(19) United States
(12) Patent Application Publication
(10) Pub. No.: US 2023/0196100 A1
(43) Pub. Date: Jun. 22, 2023

(54) INFORMATION PROCESSING METHOD AND INFORMATION PROCESSING DEVICE

(71) Applicant: Fujitsu Limited, Kawasaki-shi (JP)

(72) Inventors: Yuichiro WADA, Setagaya (JP); Takafumi KANAMORI, Meguro (JP); Yuhui ZHANG, Meguro (JP); Kaito GOTO, Meguro (JP); Yusaku HINO, Meguro (JP)

(73) Assignee: Fujitsu Limited, Kawasaki-shi (JP)

(21) Appl. No.: 17/972,730

(22) Filed: Oct. 25, 2022

(30) Foreign Application Priority Data
Dec. 22, 2021 (JP) 2021-208315

(51) Int. Cl. G06N 3/08

(52) U.S. Cl. CPC G06N 3/08

(57) ABSTRACT

A non-transitory computer-readable recording medium stores a program for causing a computer to execute a process that includes acquiring a dataset without including correct answer data, generating a first constraint condition used to maximize mutual information between each data point included in the dataset and a class label assigned to the each data point, generating a second constraint condition that reduces a distribution distance regarding class labels assigned to two data points between which a Euclidean distance is closer than a predetermined value, generating a third constraint condition that reduces a distribution distance regarding class labels assigned to data points estimated to have a same class label, and increases a distribution distance regarding class labels assigned to data points estimated to have different class labels, and training a neural network that performs data classification, by performing optimization processing based on the first, second, and third constraint conditions.

### CROSS-REFERENCE TO RELATED APPLICATION

This application is based upon and claims the benefit of priority of the prior Japanese Patent Application No, 2021-208315, filed on Dec. 22, 2021, the entire contents of which are incorporated herein by reference.

### FIELD

The embodiment discussed herein relates to an information processing method and an information processing device.

### BACKGROUND

In recent years, artificial intelligence (AI) has been used in various fields. Machine learning is exemplified as an important technique for utilizing the AI. Machine learning is roughly divided into supervised learning which requires correct answer data to perform learning and unsupervised learning which does not require the correct answer data to perform learning.

Because unsupervised learning does not use the correct answer data, there is an advantage that data may be easily prepared as compared with supervised learning. There is a case where unsupervised learning is used for classification, and the classification using unsupervised learning may be referred to as unsupervised classification.

Unsupervised classification is a wide concept including clustering. Clustering in unsupervised learning is a classification method for dividing an unlabeled dataset into subsets of a specified number of clusters in a case where the unlabeled dataset and the number of clusters thereof are given. On the other hand, an object of unsupervised classification is to train a statistical model with the unlabeled dataset and the number of clusters thereof and accurately predict a class label using the trained statistical model for unknown data. In unsupervised classification, a statistical model including a neural network (NN) is often used to perform prediction with higher accuracy. Then, by inputting the unlabeled dataset used for learning into the trained statistical model and predicting a class label of each piece of data, unsupervised classification may be interpreted as clustering.

There are many classical clustering methods that do not use neural networks. However, most classical clustering methods handle low-dimensional datasets.

Therefore, in order to handle high-dimensional datasets in unsupervised learning, a method based on a policy of using deep clustering using a neural network is proposed.

Deep clustering is a classification method using a deep neural network as a statistical model. In deep clustering, after information regarding an unlabeled dataset and the number of clusters is given, the statistical model is trained so that clustering into the given number of clusters is successfully performed for a large number of data points. A final layer of the deep neural network used for deep clustering is defined by a softmax function, and a dimension thereof matches the given number of clusters. Note that, although being referred to as deep clustering (deep clustering) for convenience, the training statistical model may actually handle unsupervised classification problems in many cases. This is because, through training, the statistical model is generalized to an unknown distribution generated with data points included in the unlabeled dataset.

Deep clustering is different from classical clustering as follows. For one, deep clustering may process a large-scale dataset within practical computational time. This is because the deep neural network may be trained with stochastic gradient descent (SGD). Furthermore, as another one, deep clustering may improve expressiveness of the statistical model. As a result, higher-dimensional data may be easily handled when unsupervised learning is performed.

For prediction with higher accuracy, it is preferable to perform deep learning clustering as incorporating a concept of manifolds. The manifold represents a shape of data formed by connection between data points. Deep clustering incorporating the concept of manifolds makes it possible to perform unsupervised learning using a dataset having a simple manifold structure including a high-dimensional manifold. Here, the simple manifold indicates a manifold formed by a Gaussian mixture model or a dataset that may be approximated to that. Conversely, a complex manifold indicates manifolds other than simple manifolds. Furthermore, a low dimension indicates a dimension about two or three dimensions, and a high dimension includes each dimension other than the low dimension and larger than the low dimension.

Traditionally, under setting in which a plurality of data points feature-vectorized and the number of clusters thereof are given before a statistical model including a neural network is trained, there are two representative unsupervised classification methods.

One is a method called information maximization for self-augmented training (IMSAT). The IMSAT is a method for performing clustering as combining two types of learning including learning through information maximization (IM) and learning for smoothing a predicted distribution using data augmentation. The ISMAT may predict datasets belonging to a low-dimensional and simple manifold and a high-dimensional and simple manifold with high accuracy.

Another one is a method called SpectralNet. The SpectralNet is a method for predicting a class by a neural network that classifies classes, using similarity information obtained from a first neural network used to measure a similarity between two points. It is considered that the SpectralNet may handle a dataset belonging to a low-dimensional and complex manifold. When the SpectralNet is performed, two neural networks including a Siamese-NN used to extract manifold information and an NN for unsupervised classification are used.

Traditionally, as a technique regarding the ISMAT, the following techniques exist. For example, a technique has been proposed that updates a parameter of a prediction model so as to minimize a sum of inter-distribution distances of respective multiple small categorical distributions that are components of a posterior probability distribution when the posterior probability distribution of a prediction model that predicts a label sequence is smoothed. Furthermore, a technique of a pseudo recurrent neural network that alternately includes convolutions layers, which extend in a temporal direction and are applied in parallel, and minimalist recursive pooling layers, which extend in a feature dimensional direction and are applied in parallel, has been proposed. Furthermore, a technique has been proposed that computationally establishes a mutual information estimation framework using a specific configuration of a computational element in machine learning, explores a hidden connection of a next sentence prediction (NSP) to mutual information maximization, and maximizes mutual information of sequence variables. Furthermore, a technique has been proposed that estimates a probability that each full text is correct by generating at least one wrong sentence from a corpus including a plurality of sentences and distinguishing a sentence of which a full text is correct as performing training using the generated wrong sentence.

Here, in a framework of a traditional method, a method of deep clustering is considered that correctively handles datasets belonging to simple manifolds with dimensions from a low dimension to a high dimension and datasets belonging to low-dimensional complex manifolds. For example, as one of simple methods, a method is considered for combining algorithms of both of the IMSAT and the SpectralNet into one.

Japanese Laid-open Patent Publication No. 2020-87148, Japanese National Publication of International Patent Application No. 2020-501231, U.S. Patent Application Publication No. 2020/0285964, and U.S. Patent Application Publication No. 2019/0318732 are disclosed as related art.

W. Hu, T. Miyato, S. Tokui, E. Matsumoto, and M. Sugiyama, “Learning discrete representations via information maximizing self-augmented training/” in International Conference on Machine Learning, pp. 1558-1567, 2017. is also disclosed as related art.

### SUMMARY

According to an aspect of the embodiment, a non-transitory computer-readable recording medium stores a program for causing a computer to execute a process, the process includes acquiring a dataset without including correct answer data, generating a first constraint condition used to maximize mutual information between each of data points included in the dataset and a class label assigned to the each of the data points, generating a second constraint condition that reduces a distribution distance regarding class labels assigned to two data points between which a Euclidean distance is closer than a predetermined value, generating a third constraint condition that reduces a distribution distance regarding class labels that are assigned to respective data points estimated to have a same class label, and increases a distribution distance regarding class labels that are assigned to respective data points estimated to have different class labels, and training a neural network that performs data classification, by performing optimization processing to solve an optimization problem based on the first constraint condition, the second constraint condition, and the third constraint condition.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of an information processing device according to an embodiment;

FIG. 2 is a diagram illustrating a flow of training processing by the information processing device according to the embodiment;

FIG. 3 is a diagram illustrating an effect in a case where deep clustering is performed on a high-dimensional and simple manifold using the information processing device according to the embodiment;

FIG. 4 is a diagram illustrating an effect in a case where deep clustering is performed on a low-dimensional and complex manifold using the information processing device according to the embodiment;

FIG. 5 is a flowchart of statistical model training processing by the information processing device according to the embodiment;

FIG. 6 is a diagram illustrating each of clustering results in a case where a plurality of methods is used; and

FIG. 7 is a hardware configuration diagram of the information processing device.

### DESCRIPTION OF EMBODIMENT

In a case where the algorithms of both of the IMSAT and the SpectralNet are combined into one, at least two neural networks are used. In that case, the size of the neural network increases, and a storage capacity used to save data increases. Therefore, this is not suitable for practical use. Furthermore, in terms of performance, the above is equivalent to the IMSAT and the SpectralNet, and it is difficult to improve prediction performance through machine learning.

Hereinafter, an embodiment of an information processing method and an information processing device disclosed in the present application will be described in detail with reference to the drawings. Note that the embodiment below does not limit the information processing method and the information processing device disclosed in the present application.

### Embodiment

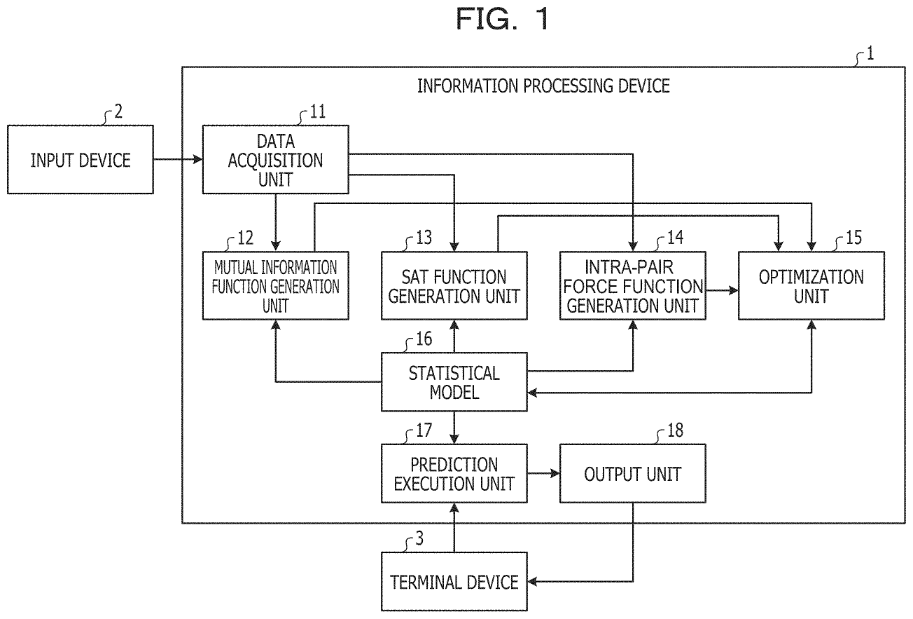

FIG. 1 is a block diagram of an information processing device according to the embodiment. An information processing device 1 according to the present embodiment is coupled to an input device 2 and a terminal device 3. The input device 2 is a device for inputting a dataset that is a data group used for machine learning performed by the information processing device 1. Furthermore, the terminal device 3 is a device that is operated by a user of the information processing device 1 and is a device used to make the information processing device 1 predict a class label of a specific piece of data and acquire a prediction result. As illustrated in FIG. 1, the information processing device 1 includes a data acquisition unit 11, a mutual information function generation unit 12, a SAT function generation unit 13, an intra-pair force function generation unit 14, an optimization unit 15, a statistical model 16, a prediction execution unit 17, and an output unit 18.

The information processing device 1 has two operation phases including a training phase and a prediction phase. In the training phase, the data acquisition unit 11, the mutual information function generation unit 12, the SAT function generation unit 13, the intra-pair force function generation unit 14, and the optimization unit 15 execute training processing of the statistical model 16. In the prediction phase, the prediction execution unit 17 and the output unit 18 predict a class label for data input using the trained statistical model 16.

The data acquisition unit 11 acquires, for example, an input of a dataset X={xᵢ}ⁿᵢ₌₁ including n feature vectors from the input device 2. The dataset acquired by the data acquisition unit 11 may be unlabeled dataset with no correct answer data. Furthermore, the data acquisition unit 11 receives an input of the number of clusters to each of which a class label is assigned, from the input device 2. Then, the data acquisition unit 11 outputs the acquired number of clusters to the mutual information function generation unit 12, the SAT function generation unit 13, the intra-pair force function generation unit 14, and the optimization unit 15. Furthermore, the data acquisition unit 11 outputs the acquired dataset to the optimization unit 15.

The mutual information function generation unit 12 generates a function of mutual information indicated by the following formula (1) using the number of clusters in clustering to be performed and the statistical model 16. Here, the mutual information (MI) is an amount representing a degree of interdependence between a certain data point and its class label.

ηH(Y)−H(Y|X) (1)

Here, X represents a dataset, and Y represents a set of class label y given to each data point x included in the dataset X. Furthermore, H(Y) represents an entropy of a distribution of a prediction result of an entire dataset. Furthermore, H(Y|X) represents an entropy of a distribution of a prediction result of individual prediction. Furthermore, η is a hyperparameter for adjustment. The formula (1) represents mutual information between the data point x and the class label y of that data point. Maximizing H(Y) gives the same class label to data points close to each other. Furthermore, by decreasing H(Y|X), data points having the same class label are collected in a close region.

Thereafter, the mutual information function generation unit 12 outputs the generated function for maximizing the mutual information indicated in the formula (1) to the optimization unit 15. A condition represented by the function for maximizing the mutual information corresponds to an example of a first constraint condition for maximizing mutual information between each data point included in a dataset and a class label assigned to each data point.

The SAT function generation unit 13 generates a function for SAT indicated by the following formula (2) using the number of clusters in clustering to be performed and the statistical model 16. Here, θ represents a parameter of a neural network included in the statistical model 16.

[symbol]

_{X˜p(x)}[Fᵥₐₜ(X;θ)]≤δ₁ (2)

The SAT is processing for smoothing distribution and is also referred to as virtual adversarial training (VAT). Hereinafter, the SAT will be described. A neural network that performs clustering to be learned is defined by the following formulas (3) and (4). Here, R^{d} represents a d-dimensional Euclidean space.

g_{θ}: [symbol] ^{d}→Δ^{C} (3)

Δ^{C}={z∈ [symbol] ^{C}|z≥0,z^{T}1=1} (4)

In the formula (4), Δ^{C} represents a set of C-dimensional probability vectors (vector satisfying that each element is equal to or more than zero and sum of all elements is one), Furthermore, one in bold indicates a C-dimensional vector of which all the elements are one. Here, C represents the number of clusters. Furthermore, θ represents a parameter existing in a neural network. An output g_{θ}(x) indicates a probability that a data point belongs to each of clusters with ranges of one, . . . , and C.

By performing the SAT, the following formula (5) is satisfied by an arbitrary point x′ in ε (>0) centered on the data point x. Here, it may be said that x′ is a point of which the Euclidean distance to the data point x is close.

g_{θ}(xᵢ)≈g_{θ}(xⱼ) (5)

That is, by executing the SAT, an output of the neural network is smoothed inside of the neighborhood centered on the data point x.

Here, when it is assumed that a state of a parameter obtained through t times of the stochastic gradient descent (SCD) be θt, the SAT is performed in the following procedure. First, r_{adv} is specified of which a value with g_{θt}(x) is the most different direction in terms of a Kullback Leibler (KL) distance, within a radius of s centered on the data point x that is an element of R^{d}. Next, θ that is the parameter of the neural network is adjusted so as to shorten the KL distance between g_{θt}(x) and g_{θ}(x×r_{adv}). In other words, Rᵥₐₜ in the formula (2) is a function that smooths a distribution within a radius of E centered on the data point x, for example, Rᵥₐₜ in the formula (2) is a function that forces two data points close to each other to have the same class label and is a function that reduces a distribution distance that is the KL distance between the two data points. Then, the formula (2) is a function representing processing executed in the SAT. A condition that satisfies the function for the SAT corresponds to an example of a second constraint condition that reduces a distribution distance regarding the class labels respectively assigned to two data points between which the Euclidean distance is close. Hereinafter, the above-described processing executed by the SAT function generation unit 13 is referred to as Self-Augmentation.

Thereafter, the SAT function generation unit 13 outputs the generated function for the SAT indicated by the formula (2) to the optimization unit 15.

The intra-pair force function generation unit 14 generates an intra-pair force function representing a force between two data points to be paired indicated in the following formula (6) using the number of clusters in clustering to be performed and the statistical model 16.

$${M}^{′} - {δ}_{2}^{′} \leq \frac{{I}_{nce} + {I}_{nce}^{′}}{2} \leq {M}^{′} \qquad ( 6 )$$

Here, I_{nce} represents a loss based on noise contrastive estimation (InfoNCE) and is given in the following formula (7).

$$\frac{1}{\vert B \vert} {\sum }_{{x}_{i} ∈ B} log \frac{{e}^{q ( {g}_{θ} ( {x}_{i} ) , {g}_{θ} ( {t}_{i} ( {x}_{i} ) ) )}}{\frac{1}{\vert B \vert} {\sum }_{{x}_{j} ∈ B} {e}^{q ( {g}_{θ} ( {x}_{i} ) , {g}_{θ} ( {t}_{j} ( {x}_{j} ) ) )}} \qquad ( 7 )$$

Here, q represents a function that defines a similarity between two probability vectors. Furthermore, I′_{nce} is given in the following formula (8).

$$\frac{1}{\vert B \vert} {\sum }_{{x}_{i} ∈ B} log \frac{{e}^{q ( {g}_{θ} ( {t}_{i} ( {x}_{i} ) ) , {g}_{θ} ( {x}_{i} ) )}}{\frac{1}{\vert B \vert} {\sum }_{{x}_{j} ∈ B} {e}^{q ( {g}_{θ} ( {t}_{i} ( {x}_{i} ) , {g}_{θ} ( {x}_{j} ) )}} \qquad ( 8 )$$

For example, in a case where the formula (7) is expressed as InfoNCE(g_{θ}(x), g_{θ}(t(x))) as a function of g_{θ}(x) and g_{θ}(t(x)), the formula (8) is expressed as InfoNCE(g_{θ}(t(x)), g_{θ}(x)). InfoNCE(g_{θ}(x), g_{θ}(t(x))) has no symmetry with respect to g_{θ}(x) and g_{θ}(t(x)). Therefore, by adding I_{nce} and I′_{nce}, which is derived from I_{nce} by reversing parameters thereof, and dividing the result by two, a function that represents a loss based on the noise-contrastive estimation and has symmetry is generated.

Then, by substituting the formulas (7) and (8) into the formula (6) and rearranging the formula, the following formula (9) is obtained,

$$- log \vert B \vert - \frac{1}{\vert B \vert} q ( {g}_{θ} ( {x}_{i} ) , {g}_{θ} ( {t}_{i} ( {x}_{i} ) ) ) + \frac{1}{2 \vert B \vert} {\sum }_{{x}_{i} ∈ B} log ( {\sum }_{{x}_{i} ∈ B} {\sum }_{{x}_{i}^{′} ∈ B} {e}^{a ( i , {i}^{′} , j )} ) \qquad ( 9 )$$

Here, the second term of the formula (9) represents a force acting between data points belonging to the same cluster. Here, a pair of data points belonging to the same manifold is referred to as a positive pair. A loss function represented by the second term of the formula (9) is referred to as a positive loss and is represented as Lps. As the positive loss is larger, the stronger attractive force acts between data points that form a positive pair, and the data points approach each other.

The third term of the formula (9) represents a force acting between data points belonging to different clusters. Here, a pair of data points belonging to different manifolds is referred to as a negative pair. A loss function represented by the third term of the formula (9) is referred to as a negative loss and is represented as Lng. As the negative loss is larger, the stronger repulsive force acts between data points that form a negative pair, and the data points move away from each other.

From the above, (I_{nce}+I′_{nce})/2 in the formula (6) may be considered as a sum of Lps and Lng, except for the first term that is a constant. The function indicated by the formula (6) generated by the intra-pair force function generation unit 14 represents that the sum of Lps and Lng is maximized. Then, by maximizing the formula (6), the positive pair is attracted to each other, and the negative pair is separated from each other. Therefore, class classification is more clarified. For example, the formula (6) corresponds to an example of a third constraint condition that reduces a distance between data points that are estimated to have the same class label and increases a distance between data points that are estimated to have different class labels.

As described above, according to the formula (6) generated by the intra-pair force function generation unit 14, it is possible to match clusters to which respective two points belonging to the same manifold belong. For example, a case will be described where a manifold M and a pair of data points (xi, xj) exist and both of xi and xj belong to the manifold M. At this time, by satisfying the formula (6) generated by the intra-pair force function generation unit 14, probability distribution representations of the two points xi and xj become sufficiently close. As definition of proximity in this case, (I_{nce}+I′_{nce})/2 in the formula (6) is used. That is, xi and xj have a property indicated by the formula (10), In the following, processing for satisfying the condition indicated in the formula (6) generated by the intra-pair force function generation unit 14 is referred to as intra-pair force adjustment.

g_{θ}(xᵢ)≈g_{θ}(xᵢ) (10)

In this case, θ is a parameter existing in a neural network. Furthermore, g_{θ}(x) is a function representing a probability that a data point belongs to each of clusters with ranges of one, . . . , and C in a case where C represents the number of clusters.

However, it is generally difficult for the intra-pair force function generation unit 14 to obtain a pair of two data points belonging to the same manifold as initial information. Therefore, the intra-pair force function generation unit 14 constructs the pair of data points belonging to the same manifold. For example, the intra-pair force function generation unit 14 achieves construction of the pair of data points belonging to the same manifold by defining xj with t(xi) starting from xi, Here, t represents a conversion function from the d-dimensional Euclidean space into the d-dimensional Euclidean space.

For example, in a case of a low-dimensional complex manifold, the intra-pair force function generation unit 14 defines t using a geodesic line distance, Here, the geodesic line distance is defined via a k-nearest neighbor (NN) graph. In a case of a simple manifold, the intra-pair force function generation unit 14 defines t using the Euclidean distance.

Thereafter, the intra-pair force function generation unit 14 outputs the generated intra-pair force function indicated by the formula (6) to the optimization unit 15.

The optimization unit 15 receives an input of the function for maximizing the mutual information indicated by the formula (1) from the mutual information function generation unit 12. Furthermore, the optimization unit 15 receives an input of the function for the SAT indicated by the formula (2) from the SAT function generation unit 13. Furthermore, the optimization unit 15 receives an input of the intra-pair force function indicated by the formula (6) from the intra-pair force function generation unit 14. Moreover, the optimization unit 15 receives inputs of the dataset and the number of clusters from the data acquisition unit 11.

Then, the optimization unit 15 trains the statistical model 16 so as to maximize the formula (1) while satisfying the formulas (2) and (6). That is, the optimization unit 15 maximizes the mutual information between the data point and the class label while satisfying a condition for minimizing a distance between distributions regarding class labels of two data points between which the Euclidean distance is close and maximizing an intra-pair function. By maximizing the intra-pair function, the optimization unit 15 increases the attractive force between the pair of data points belonging to the same manifold and increases the repulsive force between the pair of data points belonging to the different manifolds.

Then, the optimization unit 15 adjusts and optimizes the parameter of the statistical model 16 according to the training result. The optimization unit 15 repeats training of the statistical model 16 until the training processing converges or a predetermined number of times of training processing is completed. Thereafter, when the training processing converges or the predetermined number of times of training processing is completed, the optimization unit 15 gives the obtained parameter to the statistical model 16 to generate the trained statistical model 16.

The prediction execution unit 17 receives an input of data to be predicted from the terminal device 3. Then, the prediction execution unit 17 inputs the data to be predicted into the neural network of the trained statistical model 16 and acquires information regarding a class label corresponding to the data to be predicted, which is output as the prediction result. Then, the prediction execution unit 17 outputs the acquired class label to the output unit 18.

The output unit 18 acquires information regarding the class label corresponding to the data to be predicted input from the terminal device 3, from the prediction execution unit 17. Then, the output unit 18 outputs the information regarding the class label corresponding to the data to be predicted to the terminal device 3.

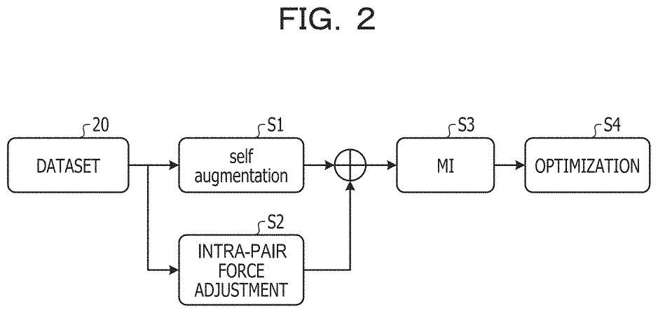

FIG. 2 is a diagram illustrating a flow of training processing by the information processing device according to the embodiment. Here, with reference to FIG. 2, the training processing by the information processing device 1 according to the present embodiment will be described.

Self-Augmentation by the SAT function generation unit 13 is performed on a dataset 20 acquired by the data acquisition unit 11, and a condition that satisfies the formula (2) is given (step S1).

Furthermore, intra-pair force adjustment by the optimization unit 15 is performed on the dataset 20 acquired by the data acquisition unit 11, and a condition that satisfies the formula (6) is given (step S2).

The optimization unit 15 acquires the mutual information (MI) that is represented by the formula (1) generated by the mutual information function generation unit 12 and is satisfied after satisfying the condition given by the Self-Augmentation and the condition given by the intra-pair force adjustment (step S3).

Then, the optimization unit 15 adjusts the parameter so as to maximize the value of the mutual information function to optimize the statistical model 16 (step S4).

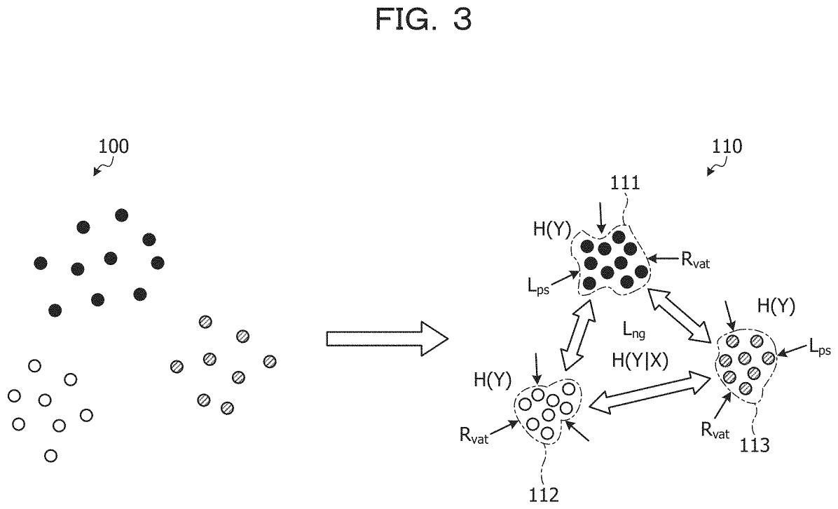

FIG. 3 is a diagram illustrating an effect in a case where deep clustering is performed on a high-dimensional and simple manifold using the information processing device according to the embodiment. Here, a dataset 100 is a high-dimensional and simple manifold that is expressed by a Gaussian mixture. In the dataset 100, points to which the same pattern is added exist on the same manifold. That is, the information processing device 1 is required to accurately assign the same class label to the points in the dataset 100 to which the same pattern is added.

By training the statistical model 16 using the information processing device 1 according to the present embodiment, a state 110 pointed by an arrow in FIG. 3 is formed. That is, the information processing device 1 forms clusters 111 to 113 from the dataset 100, as illustrated in the state 110. Here, an effect on clustering by each of the formulas (1), (2), and (6) used for training by the information processing device 1 will be described. The clusters 111 to 113 are roughly divided by H(Y) in the formula (1). Furthermore, the clusters 111 to 113 are clearly separated from each other by H(Y|X) in the formula (1). Moreover, the data points belonging to each of the clusters 111 to 113 are brought closer to each other by Rᵥₐₜ in the formula (2). Furthermore, the data points belonging to each of the clusters 111 to 113 are brought closer to each other by Lps in the formula (6). Furthermore, the data points belonging to the different manifolds of the manifolds indicated by the clusters 111 to 113 are separated from each other by Lng in the formula (6). As a result, the information processing device 1 may clearly classify each of the clusters 111 to 113.

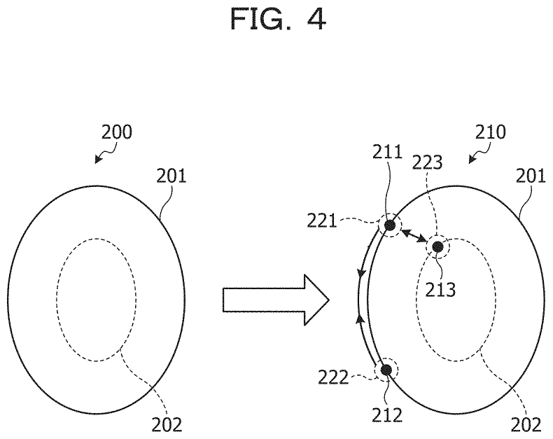

FIG. 4 is a diagram illustrating an effect in a case where deep clustering is performed on a low-dimensional and complex manifold using the information processing device according to the embodiment. Here, a dataset 200 is a manifold represented by Tow-Rings. The dataset 200 belongs to either one of manifolds 201 or 202. That is, the information processing device 1 is required to accurately assign the same first class label to points belonging to the manifold 201 and accurately assign the same second class label to points belonging to the manifold 202.

By training the statistical model 16 using the information processing device 1 according to the present embodiment, a state 210 pointed by an arrow in FIG. 4 is formed. That is, the information processing device 1 generates a cluster representing the manifold 201 and a cluster representing the manifold 202 from the dataset 200, as illustrated in the state 210. Here, an effect on clustering by each of the formulas (1), (2), and (6) used for training by the information processing device 1 will be described. Here, data points 211 and 212 belonging to the manifold 201 and a data point 213 belonging to the manifold 202 will be described. The manifolds 201 and 202 are roughly divided as clusters by H(Y) in the formula (1). Furthermore, the manifolds 201 and 202 are clearly separated from each other by H(Y|X) in the formula (1). Moreover, by Rᵥₐₜ in the formula (2), a distribution of class labels in a neighborhood 221 of the data point 211 is smoothed, a distribution of class labels in a neighborhood 222 of the data point 212 is smoothed, and a distribution of class labels in a neighborhood 223 of the data point 213 is smoothed. Furthermore, the data points 211 and 212 are brought closer to each other by Lps in the formula (6). Furthermore, the data points 211 and 213 are separated from each other by Lng in the formula (6). As a result, the information processing device 1 may clearly classify each of the data point belonging to the manifold 201 and the data point belonging to the manifold 202 into different clusters.

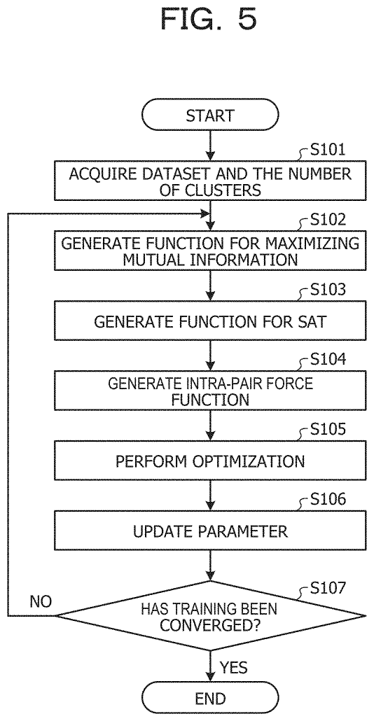

FIG. 5 is a flowchart of training processing of a statistical model by the information processing device according to the embodiment, Next, a flow of the training processing of the statistical model 16 by the information processing device 1 according to the present embodiment will be described with reference to FIG. 5.

The data acquisition unit 11 acquires a dataset and the number of dusters from the input device 2 (step S101). The data acquisition unit 11 notifies the mutual information function generation unit 12, the SAT function generation unit 13, the intra-pair force function generation unit 14, and the optimization unit 15 of the number of dusters. Furthermore, the data acquisition unit 11 outputs the dataset to the optimization unit 15.

The mutual information function generation unit 12 acquires the statistical model 16 and generates a function for maximizing the mutual information indicated by the formula (1) by using the number of clusters (step S102). Then, the mutual information function generation unit 12 outputs the generated function for maximizing the mutual information to the optimization unit 15.

The SAT function generation unit 13 acquires the statistical model 16 and generates a function for the SAT indicated by the formula (2) by using the number of clusters (step S103). Then, the SAT function generation unit 13 outputs the generated function for the SAT to the optimization unit 15.

The intra-pair force function generation unit 14 acquires the statistical model 16 and generates an intra-pair force function indicated by the formula (6) by using the number of clusters (step S104). Then, the intra-pair force function generation unit 14 outputs the generated function for the SAT to the optimization unit 15.

The optimization unit 15 acquires the function for maximizing the mutual information indicated by the formula (1), the function for the SAT, and the intra-pair force function. Then, the optimization unit 15 optimizes the statistical model 16 through training for maximizing the formula (1) while satisfying the formulas (2) and (6), using the dataset and the number of clusters (step S105).

Thereafter, the optimization unit 15 updates the parameter of the statistical model 16 with a parameter obtained through optimization (step S106).

Next, the optimization unit 15 determines whether or not training converges (step S107), In a case where training does not converge (step S107: No), the training processing returns to step S102. On the other hand, in a case where training converges (step S107: Yes), the optimization unit 15 ends the training processing,

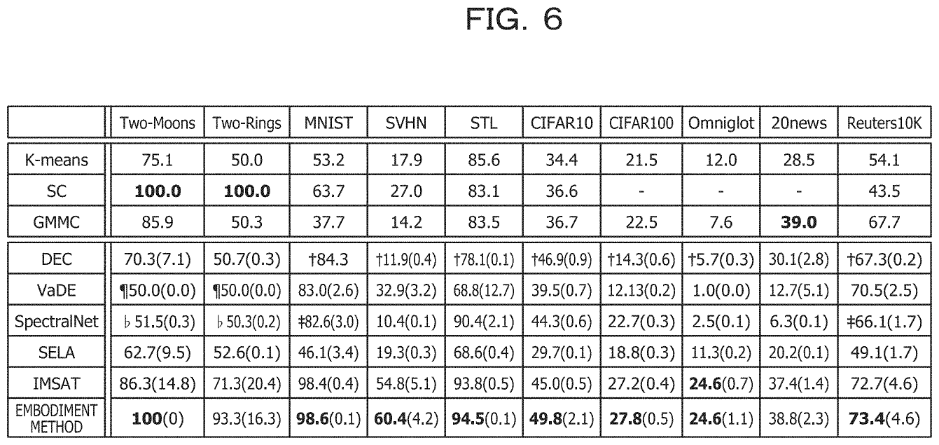

FIG. 6 is a diagram illustrating each of clustering results in a case where a plurality of methods is used. Here, two datasets including Two-Moons and Two-Rings are used as datasets with a low-dimensional and complex manifold structure. Furthermore, as datasets with a high-dimensional and simple manifold structure, eight datasets including Mixed National Institute of Standards and Technology database (MNIST), street view house numbers (SVHN), STL, CIFAR10, CIFAR100, Omniglot, 20news, and Reuters10K are used.

The following method is used as a clustering method to be compared. As classical clustering methods, three methods including K-means, spectral clustering (SC), and gaussian mixture models clustering (GMMC) are used. Furthermore, as deep clustering methods, six clustering methods including deep embedding clustering (DEC), Variational Deep Embedding (VaDE), Spectral Net, self-labelling (SELA), information maximizing self-augmented training (IMSAT) and the clustering method by the information processing device 1 according to the present embodiment are used. In FIG. 6, the clustering method by the information processing device 1 according to the present embodiment is represented as an “embodiment method”.

While setting the maximum value of clustering accuracy as 100%, seven times of clustering is performed, and an evaluation index represents average clustering accuracy of these. Furthermore, a number in parentheses in FIG. 6 indicates a standard deviation.

As illustrated in FIG. 6, the clustering method by the information processing device 1 according to the present embodiment achieves a clustering result with higher accuracy than each method of classical clustering and deep clustering, in almost all of the datasets.

(Hardware Configuration)

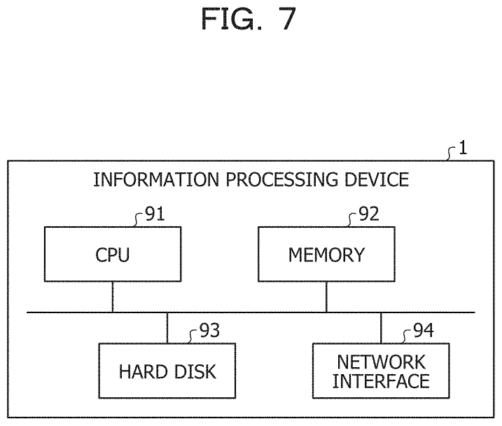

FIG. 7 is a hardware configuration diagram of an information processing device. For example, as illustrated in FIG. 7, the information processing device 1 according to the present embodiment includes a central processing unit (CPU) 91, a memory 92, a hard disk 93, and a network interface 94. The CPU 91 is coupled to the memory 92, the hard disk 93, and the network interface 94 via a bus.

The network interface 94 is a communication interface between the information processing device 1 and an external device such as the input device 2 or the terminal device 3. For example, the network interface 94 implements a function of the output unit 18.

The hard disk 93 is an auxiliary storage device. The hard disk 93 stores, for example, the statistical model 16. Furthermore, the hard disk 93 stores various programs including programs for implementing functions of the data acquisition unit 11, the mutual information function generation unit 12, the SAT function generation unit 13, the intra-pair force function generation unit 14, the optimization unit 15, and the prediction execution unit 17 illustrated in FIG. 1.

The memory 92 is a main storage device. The memory 92 is, for example, a dynamic random access memory (DRAM).

The CPU 91 reads the various programs from the hard disk 93 and loads the read programs on the memory 92 to execute the programs. As a result, the CPU 91 implements the functions of the data acquisition unit 11, the mutual information function generation unit 12, the SAT function generation unit 13, the intra-pair force function generation unit 14, the optimization unit 15, and the prediction execution unit 17 illustrated in FIG. 1.

As described above, the information processing device according to the present embodiment smooths the distribution of the class labels in the neighborhood of the data point, makes an attractive force act on the data points on the same manifold to each other, and makes a repulsive force act on the data points on the manifolds different from each other. Under that condition, the information processing device performs optimization through training so as to maximize the mutual information between the data point and the class label and adjusts the parameter of the statistical model. As a result, it is possible to classify data points more accurately for each manifold than deep clustering through typical unsupervised learning such as IMSAT or SpetralNet, and it is possible to improve prediction accuracy.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
acquiring a dataset without including correct answer data;
generating a first constraint condition used to maximize mutual information between each of data points included in the dataset and a class label assigned to the each of the data points;
generating a second constraint condition that reduces a distribution distance regarding class labels assigned to two data points between which a Euclidean distance is closer than a predetermined value;
generating a third constraint condition that reduces a distribution distance regarding class labels that are assigned to respective data points estimated to have a same class label, and increases a distribution distance regarding class labels that are assigned to respective data points estimated to have different class labels; and
training a neural network that performs data classification, by performing optimization processing to solve an optimization problem based on the first constraint condition, the second constraint condition, and the third constraint condition.

2. The non-transitory computer-readable recording medium according to claim 1, the process further comprising:
generating a pair of data points estimated to have a same class label by defining a data point, starting from each of the data points, estimated to have a class label that is same as a class label of the each of the data points by using a conversion function in a Euclidean space.

3. The non-transitory computer-readable recording medium according to claim 1, the process further comprising:
generating the third constraint condition by using a function that makes a loss based on noise-contrastive estimation have symmetry.

4. The non-transitory computer-readable recording medium according to claim 1, the process further comprising:
performing the optimization processing so as to satisfy the first constraint condition after satisfying the second constraint condition and the third constraint condition.

5. The non-transitory computer-readable recording medium according to claim 1, wherein
the distribution distance is a Kullback Leibler (KL) distance.

6. An information processing method, comprising:
acquiring, by a computer, a dataset without including correct answer data;
generating a first constraint condition used to maximize mutual information between each of data points included in the dataset and a class label assigned to the each of the data points;
generating a second constraint condition that reduces a distribution distance regarding class labels assigned to two data points between which a Euclidean distance is closer than a predetermined value;
generating a third constraint condition that reduces a distribution distance regarding class labels that are assigned to respective data points estimated to have a same class label, and increases a distribution distance regarding class labels that are assigned to respective data points estimated to have different class labels; and
training a neural network that performs data classification, by performing optimization processing to solve an optimization problem based on the first constraint condition, the second constraint condition, and the third constraint condition.

7. An information processing device, comprising:
a memory; and
a processor coupled to the memory and the processor configured to:
acquire a dataset without including correct answer data;
generate a first constraint condition used to maximize mutual information between each of data points included in the dataset and a class label assigned to the each of the data points;
generate a second constraint condition that reduces a distribution distance regarding class labels assigned to two data points between which a Euclidean distance is closer than a predetermined value;
generate a third constraint condition that reduces a distribution distance regarding class labels that are assigned to respective data points estimated to have a same class label, and increases a distribution distance regarding class labels that are assigned to respective data points estimated to have different class labels; and
train a neural network that performs data classification, by performing optimization processing to solve an optimization problem based on the first constraint condition, the second constraint condition, and the third constraint condition.
